(19) United States
(12) Patent Application Publication
(10) Pub. No.: US 2024/0278675 A1
(43) Pub. Date: Aug. 22, 2024

(54) CHARGING STATION FOR ELECTRIC VEHICLES

(71) Applicant: GM GLOBAL TECHNOLOGY OPERATIONS LLC, Detroit, MI (US)

(72) Inventors: Xiang ZHAO, Novi, MI (US); Dalong GAO, Rochester, MI (US); Mary L. MAYER, Northville Twp., MI (US); Miguel Arturo SAEZ, Clarkston, MI (US)

(21) Appl. No.: 18/110,661

(22) Filed: Feb. 16, 2023

(51) Int. Cl. B60L 53/66; B60L 53/16; B60L 53/35; B60L 53/65; B60L 53/68

(52) U.S. Cl. CPC B60L 53/66; B60L 53/16; B60L 53/35; B60L 53/65; B60L 53/68; B60L 2240/10

(57) ABSTRACT

A system for charging a plurality of vehicles parked in a parking area. The system includes an offboard vehicle control module configured to plan routes for each one of the plurality of vehicles in the parking area, and send drive instructions to an onboard control module of each one of the plurality of vehicles for driving the plurality of vehicles along the planned routes, the drive instructions including steering instructions, acceleration instructions, and brake instructions. A charging station management module is configured to execute a charging sequence for managing charging of the plurality of vehicles at a charging station, select a subject vehicle for charging from the plurality of vehicles according to the charging sequence, and send a charging notification to the offboard vehicle control module indicating that the subject vehicle has been selected for charging.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a charging station for electric vehicles.

Electric vehicles are becoming more prevalent. As a result, the number of charging stations at a parking area is often less than the number of vehicles in need of charging. For example, offices, schools, apartment buildings, shopping centers, etc. can typically accommodate hundreds of cars, but only have a handful of chargers. Parking solutions are thus needed for parking areas that typically have more cars than chargers.

### SUMMARY

In various features, the present disclosure includes a system for charging a plurality of vehicles parked in a parking area. The system includes an offboard vehicle control module configured to plan routes for each one of the plurality of vehicles in the parking area, and send drive instructions to an onboard control module of each one of the plurality of vehicles for driving the plurality of vehicles along the planned routes, the drive instructions including steering instructions, acceleration instructions, and brake instructions. A charging station management module is configured to execute a charging sequence for managing charging of the plurality of vehicles at a charging station, select a subject vehicle for charging from the plurality of vehicles according to the charging sequence, and send a charging notification to the offboard vehicle control module indicating that the subject vehicle has been selected for charging. Upon receiving the charging notification for the subject vehicle, the offboard vehicle control module is configured to send drive instructions to the onboard control module of the subject vehicle for driving the subject vehicle to the charging station along a planned route for the subject vehicle. The charging station management module is configured to monitor a charging status of the subject vehicle at the charging station, and send a charging complete notification to the offboard vehicle control module when charging of the subject vehicle is complete. Upon receiving the charging complete notification, the offboard vehicle control module is configured to send drive instructions to the onboard control module of the subject vehicle for driving the subject vehicle from the charging station to a parking space.

In further features, the charging station management module is configured to communicate with a mobile device of a user of the subject vehicle, receive a drop-off notification from the mobile device indicating that the user has dropped off the subject vehicle at a drop-off zone, and send a parking request instruction to the offboard vehicle control module. Upon receipt of the parking request instruction from the charging station management module, the offboard vehicle control module is configured to send drive instructions to the onboard control module of the subject vehicle for driving the subject vehicle from the drop-off zone to the parking space.

In further features, the charging station management module is configured to receive a pick-up notification from a mobile device indicating that a user is ready to pick-up the subject vehicle, and send a pick-up instruction to the offboard vehicle control module for picking-up the subject vehicle from the parking area. Upon receipt of the pick-up instruction from the charging station management module, the offboard vehicle control module is configured to send drive instructions to the onboard control module of the subject vehicle for driving the subject vehicle to a pick-up zone of the parking area.

In further features, the charging station management module is configured to send a charge door open instruction to the onboard control module for opening a charge door of the subject vehicle when the subject vehicle is at the charging station, and the onboard control module is configured to open the charge door.

In further features, the charging station management module is configured to send an open charge door instruction to a robotic arm of the charging station for the robotic arm to open a charge door of the subject vehicle when the subject vehicle is at the charging station.

In further features, the charging station management module is configured to send a connect charger instruction to a robotic arm of the charging station for the robotic arm to plugin a charging plug when the subject vehicle is at the charging station.

In further features, the offboard vehicle control module is configured to plan the routes for each one of the plurality of vehicles based on data received from parking sensors arranged about the parking area, the data identifying locations of the plurality of vehicles and infrastructure of the parking area.

In various features, the present disclosure includes a parking area monitoring module configured to identify locations of the plurality of vehicles in the parking area based on data received from sensors arranged about the parking area. An offboard vehicle control module is configured to plan routes for each one of the plurality of vehicles in the parking area based on the locations of the plurality of vehicles within the parking area received from the parking area monitoring module. The offboard vehicle control module is further configured to send drive instructions to an onboard control module of each one of the plurality of vehicles for driving the plurality of vehicles along the planned routes, the drive instructions including steering instructions, acceleration instructions, and brake instructions. A charging station management module is configured to execute a charging sequence for managing charging of the plurality of vehicles at the charging station, select a subject vehicle for charging from the plurality of vehicles according to the charging sequence, and send a charging notification to the offboard vehicle control module indicating that the subject vehicle has been selected for charging. Upon receiving the charging notification for the subject vehicle, the offboard vehicle control module is configured to send drive instructions to the onboard control module of the subject vehicle for driving the subject vehicle from a parking space to the charging station along the planned route for the subject vehicle. The charging station management module is configured to monitor a charging status of the subject vehicle at the charging station, and send a charging complete notification to the offboard vehicle control module when charging of the subject vehicle is complete. Upon receiving the charging complete notification, the offboard vehicle control module is configured to send drive instructions to the onboard control module of the subject vehicle for driving the subject vehicle from the charging station to the parking space or another parking space along the planned route for the subject vehicle.

In further features, the charging station management module is configured to communicate with a mobile device of a user of the subject vehicle, receive a drop-off notification from the mobile device indicating that the user has dropped off the subject vehicle at a drop-off zone, and send a parking request instruction to the offboard vehicle control module. Upon receipt of the parking request instruction from the charging station management module, the offboard vehicle control module is configured to send drive instructions to the onboard control module of the subject vehicle for driving the subject vehicle from the drop-off zone to the parking space along the planned route for the subject vehicle.

In further features, the charging station management module is configured to send the charging status to the mobile device of the user of the subject vehicle.

In further features, the charging station management module is configured to receive a pick-up notification from a mobile device indicating that a user is ready to pick-up the subject vehicle, and send a pick-up instruction to the offboard vehicle control module for picking-up the subject vehicle from the parking area. Upon receipt of the pick-up instruction from the charging station management module, the offboard vehicle control module is configured to send drive instructions to the onboard control module of the subject vehicle for driving the subject vehicle to a pick-up zone along the planned route for the subject vehicle.

In further features, the charging station management module is configured to receive the charging status of the subject vehicle from at least one of the charging station and the onboard control module of the of the subject vehicle.

In further features, the charging station management module is configured to send a charge door open instruction to the onboard control module for opening a charge door of the subject vehicle when the subject vehicle is at the charging station, and the onboard control module is configured to open the charge door.

In further features, the charging station management module is configured to send an open charge door instruction to a robotic arm of the charging station for the robotic arm to open a charge door of the subject vehicle when the subject vehicle is at the charging station.

In further features, the charging station management module is configured to send a connect charger instruction to a robotic arm of the charging station for the robotic arm to plugin a charging plug when the subject vehicle is at the charging station.

In further features, the parking area monitoring module is further configured to identify locations of infrastructure and obstacles in the parking area based on inputs received from a sensors arranged about the parking area, and the offboard vehicle control module is configured to plan the routes for each one of the plurality of vehicles based on locations of infrastructure and the obstacles.

In further features, the sensors include at least one of LIDAR, radar, and cameras.

In various features, the present disclosure includes a system for charging a plurality of vehicles parked in a parking area. The system includes a parking area monitoring module configured to identify locations of the plurality of vehicles in the parking area based on data received from sensors arranged about the parking area. An offboard vehicle control module is configured to plan routes for each one of the plurality of vehicles in the parking area based on the locations of the plurality of vehicles within the parking area received from the parking area monitoring module. The offboard vehicle control module is further configured to send drive instructions to an onboard control module of each one of the plurality of vehicles for driving the plurality of vehicles along the planned routes, the drive instructions including steering instructions, acceleration instructions, and brake instructions. A charging station management module is configured to execute a charging sequence for managing charging of the plurality of vehicles at the charging station, select a subject vehicle for charging from the plurality of vehicles according to the charging sequence, and send a charging notification to the offboard vehicle control module indicating that the subject vehicle has been selected for charging. The charging station management module is configured to communicate with a mobile device of a user of the subject vehicle, receive a drop-off notification from the mobile device indicating that the user has dropped off the subject vehicle at a drop-off zone, and send a parking request instruction to the offboard vehicle control module. Upon receipt of the parking request instruction from the charging station management module, the offboard vehicle control module is configured to send drive instructions to the onboard control module of the subject vehicle for driving the subject vehicle from the drop-off zone to a parking space along the planned route for the subject vehicle. Upon receiving the charging notification for the subject vehicle, the offboard vehicle control module is configured to send drive instructions to the onboard control module of the subject vehicle for driving the subject vehicle from the parking space to the charging station along the planned route for the subject vehicle. The charging station management module is configured to monitor a charging status of the subject vehicle at the charging station, and send a charging complete notification to the offboard vehicle control module when charging of the subject vehicle is complete. Upon receiving the charging complete notification, the offboard vehicle control module is configured to send drive instructions to the onboard control module of the subject vehicle for driving the subject vehicle from the charging station to the parking space or another parking space along the planned route for the subject vehicle. The charging station management module is configured to receive a pick-up notification from the mobile device indicating that the user is ready to pick-up the subject vehicle, and send a pick-up instruction to the offboard vehicle control module. Upon receipt of the pick-up instruction from the charging station management module, the offboard vehicle control module is configured to send drive instructions to the onboard control module of the subject vehicle for driving the subject vehicle to a pick-up zone along the planned route for the subject vehicle.

In further features, the charging station management module is configured to send a charge door open instruction to the onboard control module for opening a charge door of the subject vehicle when the subject vehicle is at the charging station, and the onboard control module is configured to open the charge door.

In further features, the charging station management module is configured to send a connect charger instruction to a robotic arm of the charging station for the robotic arm to open a charge door and plugin a charging plug when the subject vehicle is at the charging station.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates an exemplary parking area including a system in accordance with the present disclosure for charging a plurality of vehicles parked in the parking area;

FIG. 2 is a diagram of the system of the present disclosure that is implemented at the parking area of FIG. 1;

FIG. 3 illustrates an exemplary operation of the system of the present disclosure for parking a vehicle in the parking area;

FIG. 4 illustrates an exemplary operation of the system of the present disclosure for driving the vehicle to a charging area of the parking area;

FIG. 5 illustrates an exemplary operation of the system of the present disclosure for charging the vehicle and notifying a user of a charging status of the vehicle;

FIG. 6 illustrates an exemplary operation of the system of the present disclosure for driving the vehicle from the charging area to a parking space; and

FIG. 7 illustrates an exemplary operation of the system of the present disclosure for driving the vehicle to a pickup area in response to a pickup request from the user.

In the drawings, reference numbers may be reused to identify similar and/or identical elements.

### DETAILED DESCRIPTION

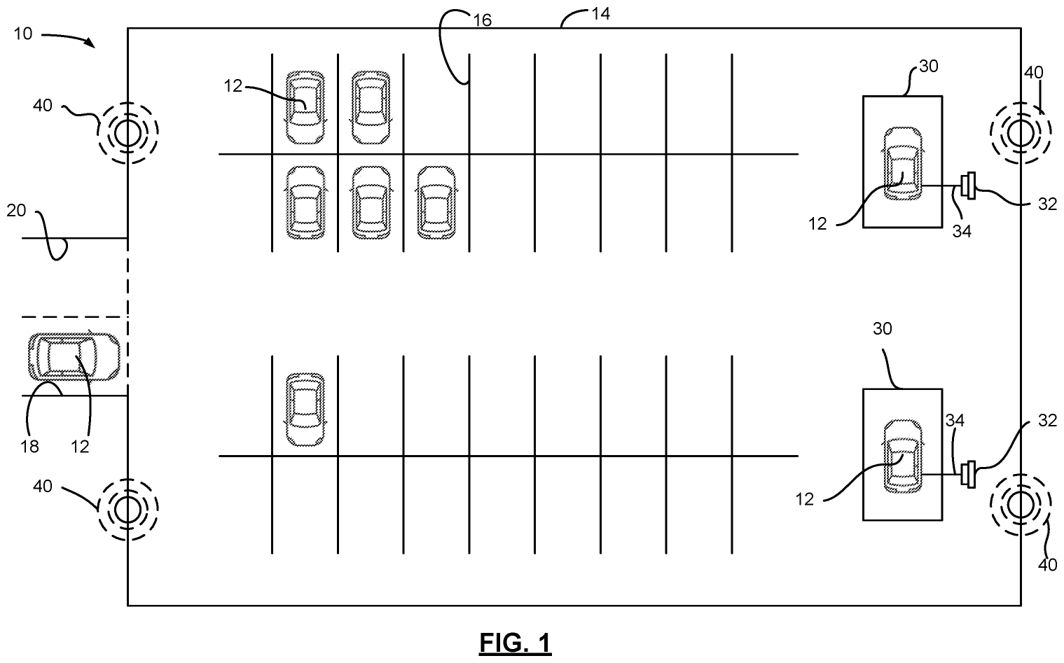

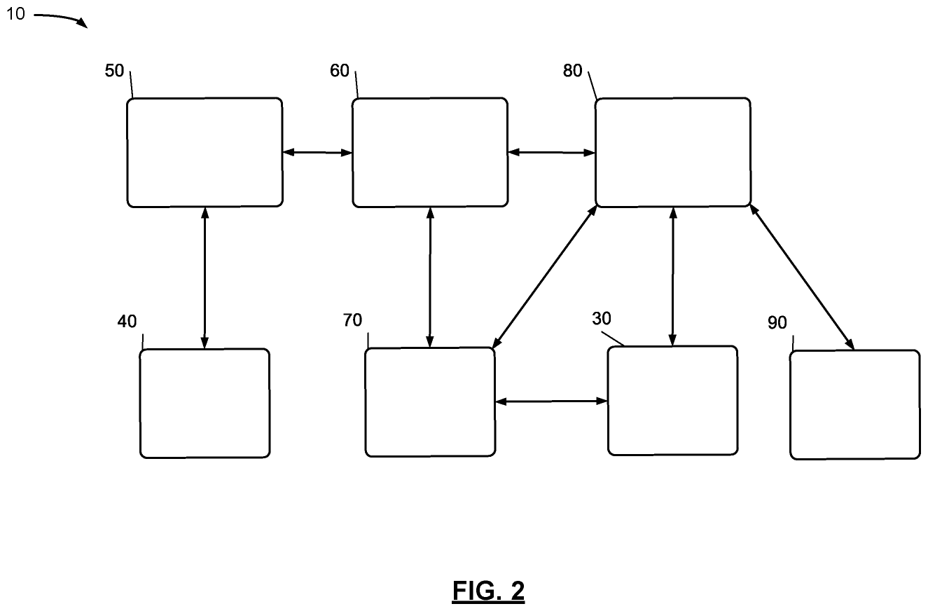

FIGS. 1 and 2 illustrate an exemplary system 10 in accordance with the present disclosure for charging a plurality of vehicles 12 at a parking area 14. The vehicles 12 may be any suitable fully electric or hybrid vehicles. For example, the vehicles 12 may be fully electric or hybrid passenger vehicles, mass transit vehicles, utility vehicles, fleet vehicles, construction vehicles, military vehicles, etc. The system 10 may also be configured for use in non-vehicular applications. For example, the system 10 may be configured for charging fully electric or hybrid equipment, such as construction equipment, agricultural equipment, military equipment, etc. The system 10 may be configured for use in any other suitable non-vehicular applications as well.

The parking area 14 may be any area suitable for parking a plurality of vehicles or equipment. For example, the parking area 14 may be a parking area of a workplace, school campus, residential buildings, commercial EV fleet operations, public transportation EV fleet operations, hospitals, shopping malls, sports arenas, amusement parks, movie theaters, etc. The parking area 14 generally includes a plurality of parking spaces 16, a vehicle drop-off zone 18, and a vehicle pickup zone 20. The drop-off and pickup zones 18, 20 may be in the same general area, or spaced apart at different locations about the parking area 14.

The parking area 14 further includes at least one charging station 30. Any suitable number of charging stations 30 may be included, such as two charging stations as illustrated in FIG. 1. The charging stations 30 may be the same or substantially similar, or may be configured differently. For example, one charging station may be fully automated, while another charging station may be operated manually by an attendant. Each charging station 30 includes a charger 32, which may be any suitable electric charger for charging the vehicles 12. The charger 32 may include any suitable robot arm 34 configured to insert a plug of the charger 32 into an outlet of the vehicle 12. The robot arm 34 may also be configured to open and close a charging door of the vehicle 12.

The parking area 14 further includes a plurality of sensors 40. Any suitable number of sensors 40 may be included for monitoring movement of the vehicles 12 throughout the parking area 14. The sensors 40 may also be configured to identify the locations of any other objects relevant to movement of the vehicles 12 throughout the parking area, such as infrastructure, obstacles, pedestrians, etc. The sensors 40 may include LIDAR, radar, cameras, or any other suitable type of sensor. The sensors 40 may be stationed at various positions about the parking area 14 to provide maximum coverage of the parking area 14.

As illustrated in FIG. 2, the parking sensors 40 are in communication with a parking area monitoring module 50. The parking area monitoring module 50 is configured to receive data from the parking area sensors 40 and process the data to identify locations of the vehicles 12 within the parking area 14, and track movement of the vehicles 12 throughout the parking area 14. The parking area monitoring module 50 also receives data from the sensors 40 indicating the presence of other obstacles within the parking area 14, such as infrastructure, pedestrians, equipment, construction, etc. The parking area monitoring module 50 is configured to receive data from the parking area sensors 40 by way of any suitable wired or wireless connection. The parking area monitoring module 50 may be located onsite at the parking area 14, or on a remote server accessible via the internet or in any other suitable manner.

The parking area monitoring module 50 is configured to send the locations of the vehicles, infrastructure, and other obstacles within the parking area 14 to an offboard vehicle control module 60 by way of any suitable wired or wireless connection. The offboard vehicle control module 60 may be on site at the parking area 14, or on a remote server accessible by the internet or any other suitable connection. The offboard vehicle control module 60 is configured to plan routes for the vehicles 12 within the parking area 14. In planning the routes, the offboard vehicle control module 60 considers locations of all of the vehicles 12, parking lot infrastructure, and any other obstacles identified by the sensors 40. For example, the offboard vehicle control module 60 is configured to plan routes for each one of the vehicles 12 from the drop off zone 18 to parking spaces 16, from the parking spaces 16 to the charging stations 30, from the charging stations 30 back to the parking spaces 16, and from the parking spaces 16 to the pickup zone 20.

The offboard vehicle control module 60 is configured to generate drive instructions for the vehicles 12 for driving the vehicles 12 along the planned routes. The drive instructions include steering instructions, acceleration instructions, and brake instructions. The offboard vehicle control module 60 is configured to send the drive instructions to an electric vehicle onboard control module 70 of each one of the vehicles 12. The offboard vehicle control module 60 is configured to communicate with the electric vehicle onboard control module 70 of the vehicles 12 by way of any suitable wireless connection, such as a 5G connection. The electric vehicle onboard control module 70 is configured to control at least steering, acceleration, and braking of the particular vehicle 12 that the module 70 is included with. The vehicles 12 need not include sophisticated sensor systems or sophisticated autonomous driving capabilities. The electric vehicle onboard control module 70 may be configured to merely control the steering, acceleration, and braking of the particular vehicle 12 that it is included with.

The system 10 further includes an EV charging station management module 80. The EV charging station management module 80 is configured to communicate with each one of the charging station 30, the offboard vehicle control module 60, the electric vehicle onboard control module 70, and any suitable mobile electronic device 90 of a user/driver of the vehicle 12. The mobile electronic device 90 may be a smartphone, tablet computer, desktop computer, wearable electronic device, etc. The EV charging station management module 80 may be onsite at the parking area 14, such as at one or more of the charging stations 30, or on an offsite server accessible by way of the internet or any other suitable connection. The charging station management module 80 is configured to transmit and receive data by way of any suitable wired or wireless connection, such as any suitable 5G connection.

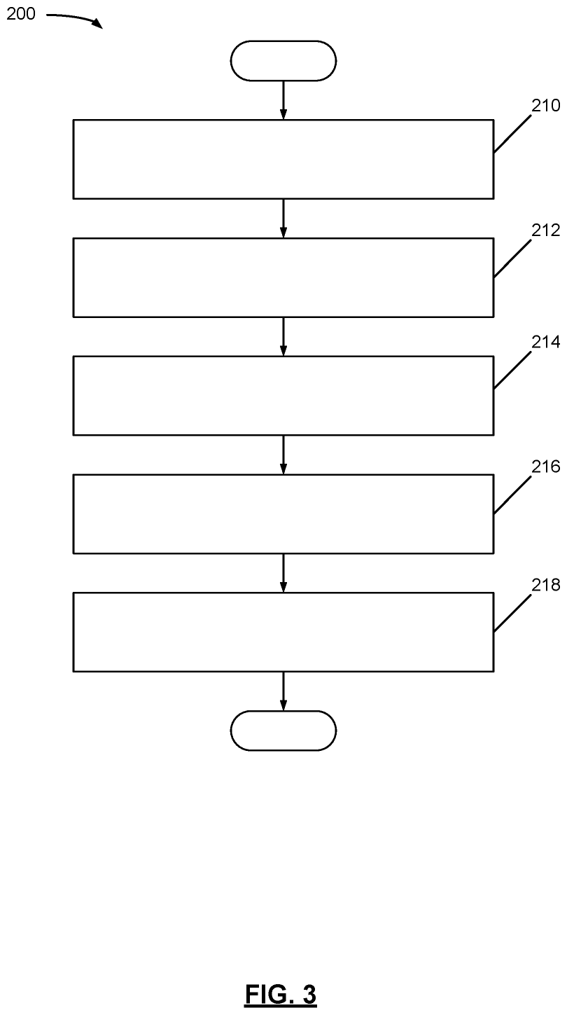

The EV charging station management module 80 is configured to execute a charging sequence for managing the charging of the plurality of vehicles 12. Any suitable charging sequence may be used, such as a “first come, first serve” charging sequence whereby the vehicles 12 are selected for charging based on the order in which they arrive at the parking area 14. Other potential charging sequences may be based on, for example, typical commuting distance of the vehicle, vehicle efficiency, typical departure time, etc. An exemplary configuration and operation of the EV charging station management module 80 is described below and illustrated in FIGS. 3, 4, 5, 6, and 7.

FIG. 3 illustrates an exemplary parking operation 200 of the system 10 for parking the vehicles 12 in the parking area 14. The parking operation 200 begins at block 210 where the charging station management module 80 receives a drop-off notification from a user or driver of the vehicle 12 by way of the mobile electronic device 90. The charging station management module 80 then sends a parking request instruction to the offboard vehicle control module 60 at block 212. At block 214, the offboard vehicle control module 60 sends drive instructions to the onboard control module 70 for driving the subject vehicle 12 from the drop off zone 18 to an open parking space 16. Upon receiving the drive instructions, at block 216 the onboard control module 70 operates the steering, acceleration, and braking of the vehicle 12 to drive the vehicle 12 to the designated parking space 16. At block 218, the charging station management module 80 adds the vehicle 12 to the charging sequence for charging the plurality of vehicles 12 parked in the parking area 14.

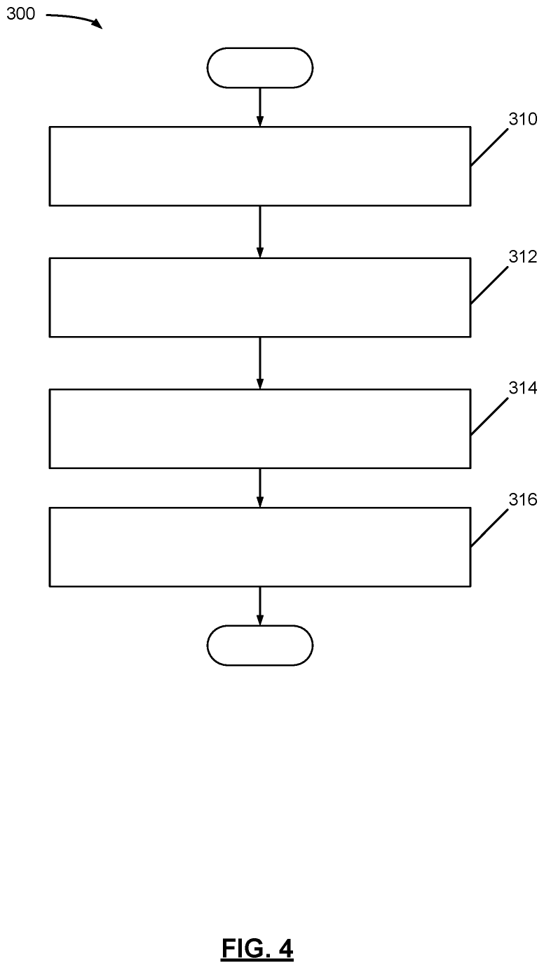

FIG. 4 illustrates an exemplary operation 300 of the system 10 for driving the vehicle 12 selected for charging to one of the charging stations 30 in order to charge the vehicle 12. At block 310, the charging station management module 80 selects one of the vehicles 12 for charging based on any suitable charging sequence when one of the charging stations 30 becomes available. For example, the vehicle 12 may be selected based on the “first come, first serve” charging sequence, typical commuting distance of the vehicle, vehicle efficiency, typical departure time, etc. At block 312, the charging station management module 80 sends a charging notification to the offboard vehicle control module 60 identifying the particular vehicle 12 that has been selected for charging. At block 314, the offboard vehicle control module 60 sends drive instructions to the onboard control module 70 of the vehicle 12 that has been selected for charging. The drive instructions are for driving the vehicle 12 along the route planned by the offboard vehicle control module 60 from the parking space 16 to the charging station 30. Based on the drive instructions, at block 316 the vehicle onboard control module 70 operates the steering, acceleration, and braking of the vehicle 12 to drive the vehicle 12 to the charging station 30. The onboard control module 70 is further configured to center or otherwise position the vehicle 12 at the charging station 30 to place the vehicle 12 within reach of the charge plug of the charger 32. The onboard control module 70 may position the vehicle 12 based on data received from onboard sensors of the vehicle 12, or based on instructions received from the offboard vehicle control module 60 using data from the sensors 40.

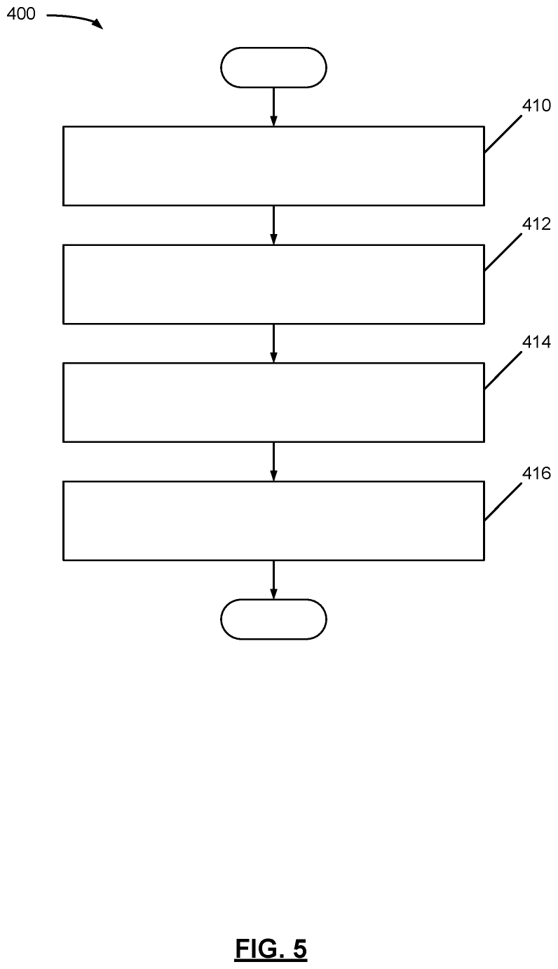

FIG. 5 illustrates an exemplary operation 400 of the system 10 for charging the vehicle 12 selected for charging, and notifying the driver/user of the vehicle 12 of the charging status. At block 410, the charging station management module 80 sends an instruction to the charging station 30 instructing the robot arm 34 to open the charge door of the vehicle 12. Alternatively, the charging station management module 80 may send an instruction directly to the onboard control module 70 for opening the charge door. In some applications, the charging station 30 may be a manual charging station with an attendant, and thus the module 80 need not send an instruction.

At block 412, the charging station management module 80 sends an instruction to the charging station 30 instructing the robot arm 34 to connect the charging plug to the vehicle. Alternatively, the charging plug may be manually connected by an attendant. At block 414, the charging station management module 80 instructs the charging station 30 to operate the charger 32 to charge the vehicle 12 to a specified charging level, such as according to the charging sequence. The charging level may be a full 100% charge, or less than a full 100% charge. At block 416, the charging station management module 80 monitors the charging process and sends charging status updates to the mobile electronic device 90 for the user.

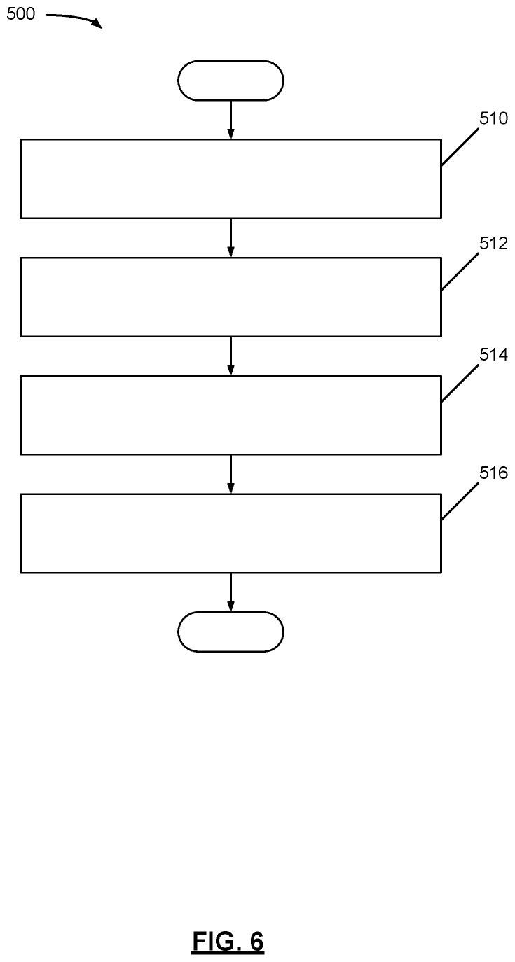

FIG. 6 illustrates an exemplary operation 500 of the system 10 for driving the vehicle 12 from the charging station 30 back to a parking space 16 after charging. At block 510 the charging station management module 80 sends a charging complete notification to the offboard vehicle control module 60 when the charging is complete. Upon receiving the charging complete notification, at block 512 the offboard vehicle control module 60 sends drive instructions to the onboard control module 70 of the charged vehicle 12 for driving the vehicle 12 from the charging station 30 to the same parking space 16 that the vehicle 12 was previously parked in, or in the case of previous parking space 16 being occupied by another vehicle 12, a different parking space 16 that is available for parking. At block 514, the onboard control module 70 operates the steering, acceleration, and braking of the vehicle 12 to drive the vehicle 12 to the parking space 16. At block 516, the charging station management module 80 sends a notification to the mobile electronic device 90 indicating that charging is complete and that the vehicle 12 is ready for pickup.

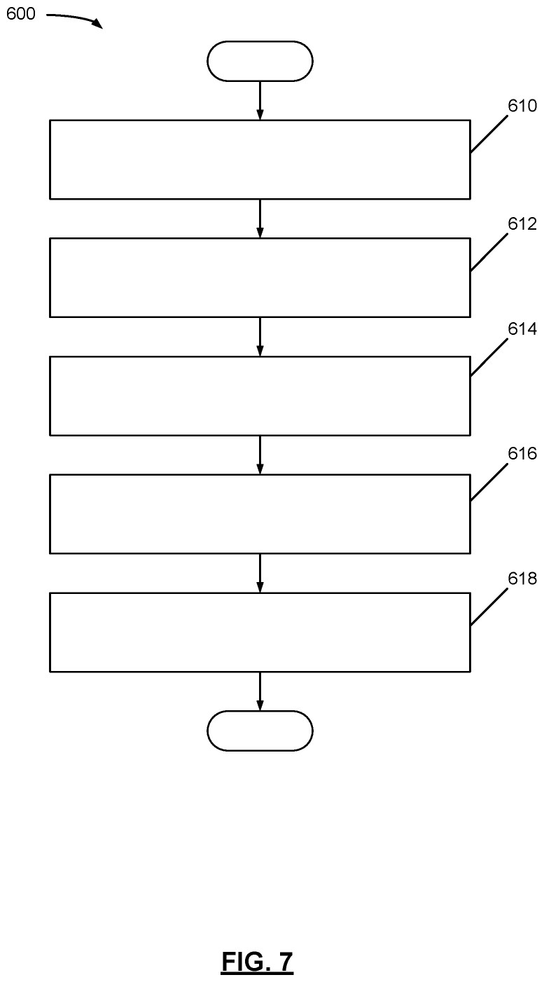

FIG. 7 illustrates an exemplary operation 600 of the system 10 for driving the charged vehicle 12 to the pickup zone 20 in response to a pickup request from the user. Specifically, at block 610, the charging station management module 80 receives a pickup request from the user by way of the mobile electronic device 90. The charging station management module 80 sends a pickup request to the offboard vehicle control module 60 at block 612. In response to receipt of the pickup request, at block 614, the offboard vehicle control module 60 sends drive instructions to the onboard control module 70 for operating the steering, acceleration, and braking of the vehicle 12 to drive the vehicle 12 along the planned route from the parking space 16 to the pickup zone 20. The planned route takes into account data received from the sensors 40 identifying locations of the vehicles 12, infrastructure, and any other obstacles within the parking area 14. At block 616, the onboard control module 70 drives the vehicle 12 to the pickup zone 20 by operating the steering, acceleration, and braking of the vehicle 12. At block 618, the onboard control module 70 informs the charging station management module 80 that the vehicle 12 is at the pickup zone 20. The charging station management module 80 then informs the user by way of the mobile electronic device 90 that the vehicle 12 is ready for pickup. The operation of the system 10 described above and illustrated in FIGS. 3-7 can be performed for any one of the vehicles 12.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for charging a plurality of vehicles parked in a parking area, the system comprising:
an offboard vehicle control module configured to plan routes for each one of the plurality of vehicles in the parking area, and send drive instructions to an onboard control module of each one of the plurality of vehicles for driving the plurality of vehicles along the planned routes, the drive instructions including steering instructions, acceleration instructions, and brake instructions; and
a charging station management module configured to execute a charging sequence for managing charging of the plurality of vehicles at a charging station, select a subject vehicle for charging from the plurality of vehicles according to the charging sequence, and send a charging notification to the offboard vehicle control module indicating that the subject vehicle has been selected for charging;
wherein:
upon receiving the charging notification for the subject vehicle, the offboard vehicle control module is configured to send drive instructions to the onboard control module of the subject vehicle for driving the subject vehicle to the charging station along a planned route for the subject vehicle;
the charging station management module is configured to monitor a charging status of the subject vehicle at the charging station, and send a charging complete notification to the offboard vehicle control module when charging of the subject vehicle is complete; and
upon receiving the charging complete notification, the offboard vehicle control module is configured to send drive instructions to the onboard control module of the subject vehicle for driving the subject vehicle from the charging station to a parking space.

2. The system of claim 1, wherein:
the charging station management module is configured to communicate with a mobile device of a user of the subject vehicle, receive a drop-off notification from the mobile device indicating that the user has dropped off the subject vehicle at a drop-off zone, and send a parking request instruction to the offboard vehicle control module; and
upon receipt of the parking request instruction from the charging station management module, the offboard vehicle control module is configured to send drive instructions to the onboard control module of the subject vehicle for driving the subject vehicle from the drop-off zone to the parking space.

3. The system of claim 1, wherein:
the charging station management module is configured to receive a pick-up notification from a mobile device indicating that a user is ready to pick-up the subject vehicle, and send a pick-up instruction to the offboard vehicle control module for picking-up the subject vehicle from the parking area; and
upon receipt of the pick-up instruction from the charging station management module, the offboard vehicle control module is configured to send drive instructions to the onboard control module of the subject vehicle for driving the subject vehicle to a pick-up zone of the parking area.

4. The system of claim 1, wherein the charging station management module is configured to send a charge door open instruction to the onboard control module for opening a charge door of the subject vehicle when the subject vehicle is at the charging station, and the onboard control module is configured to open the charge door.

5. The system of claim 1, wherein the charging station management module is configured to send an open charge door instruction to a robotic arm of the charging station for the robotic arm to open a charge door of the subject vehicle when the subject vehicle is at the charging station.

6. The system of claim 1, wherein the charging station management module is configured to send a connect charger instruction to a robotic arm of the charging station for the robotic arm to plugin a charging plug when the subject vehicle is at the charging station.

7. The system of claim 1, wherein the offboard vehicle control module is configured to plan the routes for each one of the plurality of vehicles based on data received from parking sensors arranged about the parking area, the data identifying locations of the plurality of vehicles and infrastructure of the parking area.

8. A system for charging a plurality of vehicles parked in a parking area, the system comprising:
a parking area monitoring module configured to identify locations of the plurality of vehicles in the parking area based on data received from sensors arranged about the parking area;
an offboard vehicle control module configured to plan routes for each one of the plurality of vehicles in the parking area based on the locations of the plurality of vehicles within the parking area received from the parking area monitoring module, the offboard vehicle control module further configured to send drive instructions to an onboard control module of each one of the plurality of vehicles for driving the plurality of vehicles along the planned routes, the drive instructions including steering instructions, acceleration instructions, and brake instructions; and
a charging station management module configured to execute a charging sequence for managing charging of the plurality of vehicles at a charging station, select a subject vehicle for charging from the plurality of vehicles according to the charging sequence, and send a charging notification to the offboard vehicle control module indicating that the subject vehicle has been selected for charging;
wherein:
upon receiving the charging notification for the subject vehicle, the offboard vehicle control module is configured to send drive instructions to the onboard control module of the subject vehicle for driving the subject vehicle from a parking space to the charging station along the planned route for the subject vehicle;
the charging station management module is configured to monitor a charging status of the subject vehicle at the charging station, and send a charging complete notification to the offboard vehicle control module when charging of the subject vehicle is complete; and
upon receiving the charging complete notification, the offboard vehicle control module is configured to send drive instructions to the onboard control module of the subject vehicle for driving the subject vehicle from the charging station to the parking space or another parking space along the planned route for the subject vehicle.

9. The system of claim 8, wherein:
the charging station management module is configured to communicate with a mobile device of a user of the subject vehicle, receive a drop-off notification from the mobile device indicating that the user has dropped off the subject vehicle at a drop-off zone, and send a parking request instruction to the offboard vehicle control module; and
upon receipt of the parking request instruction from the charging station management module, the offboard vehicle control module is configured to send drive instructions to the onboard control module of the subject vehicle for driving the subject vehicle from the drop-off zone to the parking space along the planned route for the subject vehicle.

10. The system of claim 9, wherein the charging station management module is configured to send the charging status to the mobile device of the user of the subject vehicle.

11. The system of claim 8, wherein:
the charging station management module is configured to receive a pick-up notification from a mobile device indicating that a user is ready to pick-up the subject vehicle, and send a pick-up instruction to the offboard vehicle control module for picking-up the subject vehicle from the parking area; and
upon receipt of the pick-up instruction from the charging station management module, the offboard vehicle control module is configured to send drive instructions to the onboard control module of the subject vehicle for driving the subject vehicle to a pick-up zone along the planned route for the subject vehicle.

12. The system of claim 8, wherein the charging station management module is configured to receive the charging status of the subject vehicle from at least one of the charging station and the onboard control module of the of the subject vehicle.

13. The system of claim 8, wherein the charging station management module is configured to send a charge door open instruction to the onboard control module for opening a charge door of the subject vehicle when the subject vehicle is at the charging station, and the onboard control module is configured to open the charge door.

14. The system of claim 8, wherein the charging station management module is configured to send an open charge door instruction to a robotic arm of the charging station for the robotic arm to open a charge door of the subject vehicle when the subject vehicle is at the charging station.

15. The system of claim 8, wherein the charging station management module is configured to send a connect charger instruction to a robotic arm of the charging station for the robotic arm to plugin a charging plug when the subject vehicle is at the charging station.

16. The system of claim 8, wherein the parking area monitoring module is further configured to identify locations of infrastructure and obstacles in the parking area based on inputs received from sensors arranged about the parking area, and the offboard vehicle control module is configured to plan the routes for each one of the plurality of vehicles based on locations of infrastructure and the obstacles.

17. The system of claim 16, wherein the sensors include at least one of LIDAR, radar, and cameras.

18. A system for charging a plurality of vehicles parked in a parking area, the system comprising:
a parking area monitoring module configured to identify locations of the plurality of vehicles in the parking area based on data received from sensors arranged about the parking area;
an offboard vehicle control module configured to plan routes for each one of the plurality of vehicles in the parking area based on the locations of the plurality of vehicles within the parking area received from the parking area monitoring module, the offboard vehicle control module further configured to send drive instructions to an onboard control module of each one of the plurality of vehicles for driving the plurality of vehicles along the planned routes, the drive instructions including steering instructions, acceleration instructions, and brake instructions; and
a charging station management module configured to execute a charging sequence for managing charging of the plurality of vehicles at a charging station, select a subject vehicle for charging from the plurality of vehicles according to the charging sequence, and send a charging notification to the offboard vehicle control module indicating that the subject vehicle has been selected for charging;
wherein:
the charging station management module is configured to communicate with a mobile device of a user of the subject vehicle, receive a drop-off notification from the mobile device indicating that the user has dropped off the subject vehicle at a drop-off zone, and send a parking request instruction to the offboard vehicle control module;
upon receipt of the parking request instruction from the charging station management module, the offboard vehicle control module is configured to send drive instructions to the onboard control module of the subject vehicle for driving the subject vehicle from the drop-off zone to a parking space along the planned route for the subject vehicle;
upon receiving the charging notification for the subject vehicle, the offboard vehicle control module is configured to send drive instructions to the onboard control module of the subject vehicle for driving the subject vehicle from the parking space to the charging station along the planned route for the subject vehicle;
the charging station management module is configured to monitor a charging status of the subject vehicle at the charging station, and send a charging complete notification to the offboard vehicle control module when charging of the subject vehicle is complete;
upon receiving the charging complete notification, the offboard vehicle control module is configured to send drive instructions to the onboard control module of the subject vehicle for driving the subject vehicle from the charging station to the parking space or another parking space along the planned route for the subject vehicle;
the charging station management module is configured to receive a pick-up notification from the mobile device indicating that the user is ready to pick-up the subject vehicle, and send a pick-up instruction to the offboard vehicle control module; and
upon receipt of the pick-up instruction from the charging station management module, the offboard vehicle control module is configured to send drive instructions to the onboard control module of the subject vehicle for driving the subject vehicle to a pick-up zone along the planned route for the subject vehicle.

19. The system of claim 18, wherein the charging station management module is configured to send a charge door open instruction to the onboard control module for opening a charge door of the subject vehicle when the subject vehicle is at the charging station, and the onboard control module is configured to open the charge door.

20. The system of claim 18, wherein the charging station management module is configured to send a connect charger instruction to a robotic arm of the charging station for the robotic arm to open a charge door and plugin a charging plug when the subject vehicle is at the charging station.
